(19) United States
(12) Patent Application Publication
(10) Pub. No.: US 2008/0115130 A1
(43) Pub. Date: May 15, 2008

(54) Method and system for launching applications in response to the closure of other applications

(76) Inventor: Michael Danninger, Landau (DE)

Correspondence Address: KENYON & KENYON LLP, 1500 K STREET N.W., WASHINGTON, DC, 20005, US

(21) Appl. No.: 11/600,247

(22) Filed: Nov. 14, 2006

(51) Int. Cl. G06F 9/46

(52) U.S. Cl. 718/100

(57) ABSTRACT

A method and system of automatically launching at least one second operation in response to the closure of a first operation of a computer. The method and system may include associating a first operation with at least one second operation. The method and system may also include determining whether the first operation has been closed. Further, the method and system may include determining the at least one second operation associated with the first operation. Finally, the method and system may include launching the at least one second operation in response to a closure of the first operation.

### FIELD OF THE INVENTION

The present invention relates to a software tool for allowing a user to customize his desktop so that certain applications are launched upon the closure of other applications or the operating system. Specifically, it enables the user to designate one or more programs to be launched upon the closure of a certain program or the operating system.

### BACKGROUND INFORMATION

A user may have specific tasks that he performs at certain times of the workday. For example, at the end of his workday, a user may input his daily hours into his company's networked program. As another example, a user may view a URL containing traffic information before he leaves the office and heads home.

Modern computer systems, such as Windows XP, contain “startup” applications which launch whenever a user begins a session on his computer. These “startup” applications consist of applications that are useful to a user when he first logs into his computer system. For example, a user may select the network email program as a startup application. It would be useful to have a mechanism that would launch programs as they were needed by the user rather than when he first logs into his system. This would avoid wasting resources by not having programs running on the system during the user's entire session. Rather, they would be launched only when needed by the user.

Microsoft Outlook possesses reminder functionalities. A user may enter an event in his personal calendar and indicate how long before the event he wishes to be reminded of it. For example, a user may have a meeting for 10 a.m. on September 30, and request to be reminded of the meeting one hour before it begins. A reminder window may then pop up on the user's computer screen at 9 a.m. on September 30 reminding the user about his 10 a.m. meeting.

### BRIEF DESCRIPTION OF THE DRAWINGS

FIG. 1 is a simplified block diagram of a computer system according to an embodiment of the present invention;

FIG. 2 is a dataflow diagram illustrating operation of one embodiment of the present invention;

FIG. 3 is an example embodiment of the present invention in a personalization dialogue of an existing application; and

FIG. 4 is an example embodiment of the present invention in a separate application.

### DETAILED DESCRIPTION

Embodiments of the present invention work cooperatively with existing software applications to automatically launch applications upon the closure of other applications or the operating system. A user may select applications, URLs, executable files, etc. that will launch when a certain application is closed or the operating system is shut down. This may be done in an independent application. Alternatively, this may be part of the personalization dialog of the application. For example, a user who works in customer support may need to manually record time entries in a separate application at the end of the day. This user may request that the time entry program be automatically launched when the user attempts to shut down his email program, such as Microsoft Outlook. As another example, a user may wish to view a URL which displays a traffic report before he leaves the office. This user may request that the traffic report URL be automatically launched when the user attempts to shut down the operating system. Once the user finishes using the automatically launched program, the operating system may continue shutting down. Alternatively, the user may be required to manually shut down the operating system.

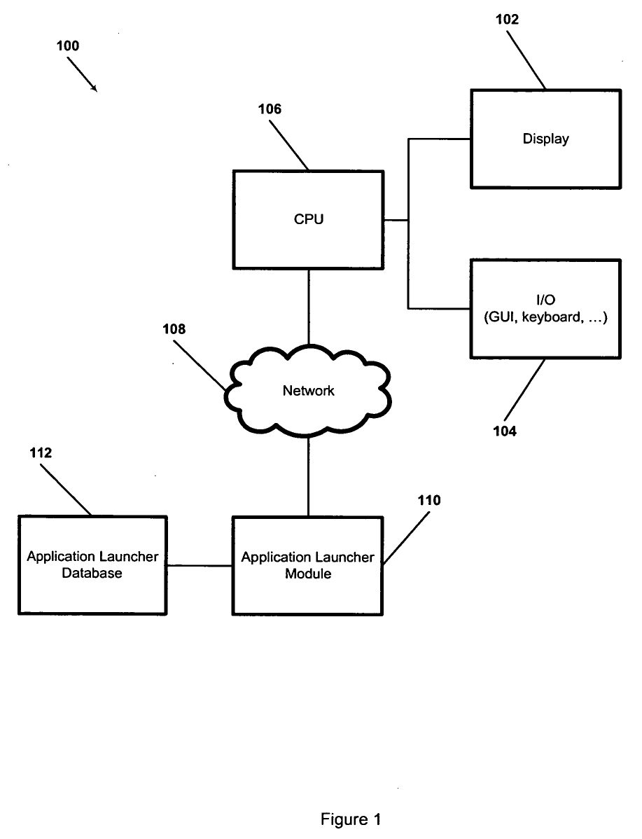

FIG. 1 is a simplified block diagram of an exemplary computer system 100 suitable for use with the present invention. The user may associate a first application with at least one second application via input/output device 104, such as a keyboard or a mouse, for example. The CPU 106 generates the association and accesses the network 108. Via the network 108, the CPU 106 passes the association onto the application launcher module 110. The application launcher module 110 then stores the association in the application launcher database 112. When the user closes the first application, the CPU 106 recognizes that the first application has been closed. Via the network 108, the CPU 106 accesses the application launcher module 110. The application module launcher 110 searches the application launcher database 112 for any applications associated with the first application. The application launcher module 110 returns any associations via the network 108 to the CPU 106. The CPU 106 then launches any applications associated with the first application that was closed. These programs are displayed to the user via the display 102. When the user finishes accessing the newly launched programs, he may then close the programs via the input/output device 104.

The user may also associate the closure of the operating system with at least one second application via input/output device 104, such as a keyboard or a mouse, for example. The CPU 106 generates the association and accesses the network 108. Via the network 108, the CPU 106 passes the association onto the application launcher module 110. The application launcher module 110 then stores the association in the application launcher database 112. When the user closes the operating system, the CPU 106 recognizes that the operating system has been closed. Via the network 108, the CPU 106 accesses the application launcher module 110. The application module launcher 110 searches the application launcher database 112 for any applications associated with the operating system. The application launcher module 110 returns any associations via the network 108 to the CPU 106. The CPU 106 then launches any applications associated with the operating system. These programs are displayed to the user via the display 102. When the user finishes accessing the newly launched programs, he may then close the programs via the input/output device 104. The CPU 106 may then continue closing down the operating system automatically. Alternatively, the user may be required to manually continue closing down the operating system.

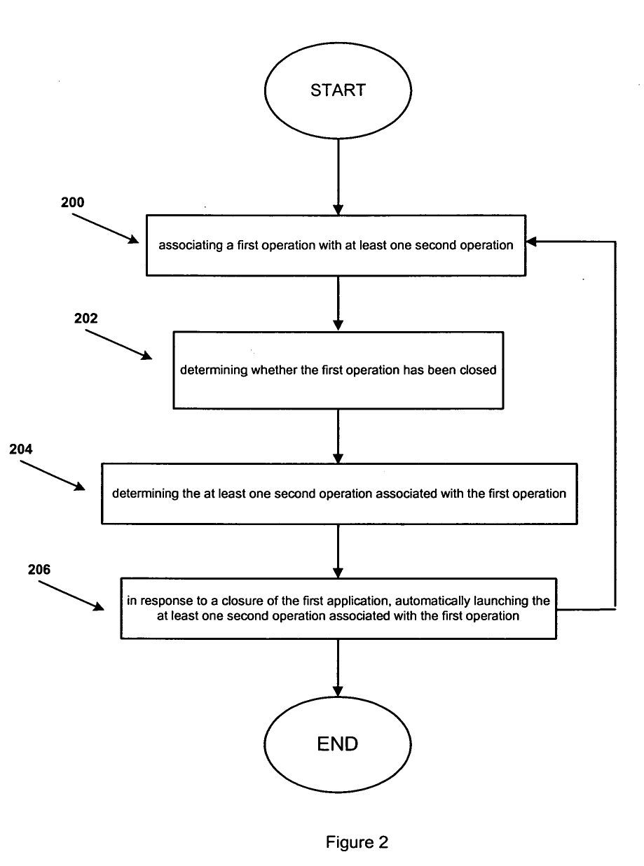

FIG. 2 is a dataflow diagram of one embodiment of the present invention. In 200, the user may associate a first operation with at least one second operation. The first operation may be an application, such as Microsoft Word. Alternatively, the first operation may be the operating system. The second operation may be an application, such as Adobe Acrobat. Alternatively, the second operation may be a URL, such as www.yahoo.com. The second operation may also be an executable file. This association may be stored in the application launcher database 112. In 202, the CPU 106 may determine whether the first operation has been closed. In 204, the CPU 106 may determine which at least one second operation is associated with the first operation. When the first operation is closed, the CPU 106 may retrieve the at least one second operation that is associated with the first operation from the application launcher database 112. In 206, in response to a closure of the first application, the CPU 106 may automatically launch the at least one second operation associated with the first operation. The at least one automatically launched second operation may be displayed to the user via the display 102.

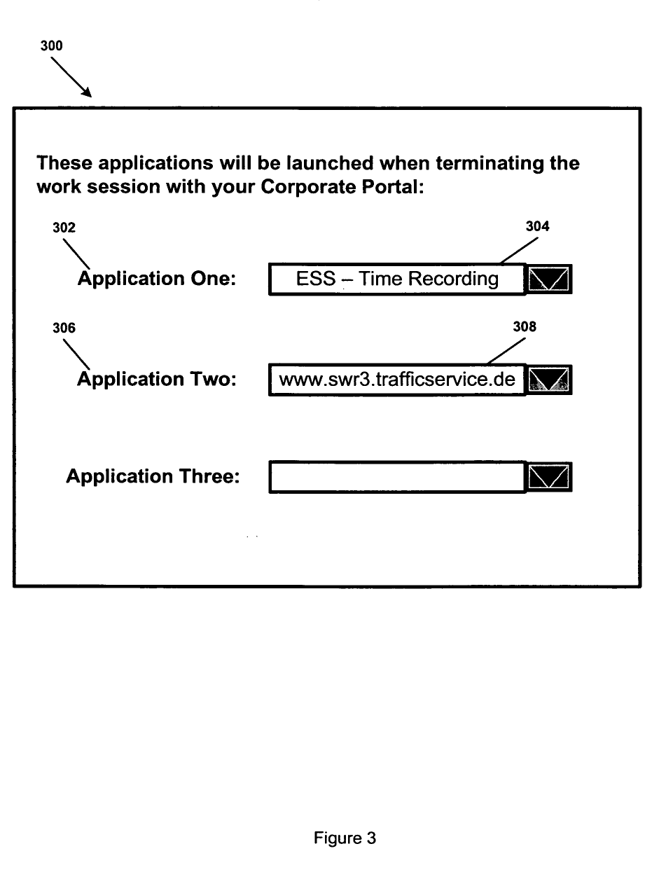

FIG. 3 is an example embodiment of the present invention in a personalization dialogue of an existing application. The application may be, for example, Microsoft Word. The existing application may also be the operating system, for example. The user may select one or more applications which will be automatically launched upon closure of the existing application. These applications may be selected via a drop down box, a check box, or any other mechanism capable of presented numerous applications to a user. For example, for Application One 302, the user may select ESS-Time Recording 304. The user may also wish for a second application to be launched upon closure of the existing application. For Application Two 306, the user may select the URL www.swr3.trafficservice.de 308. The user may not select a third application to be launched upon closure of the existing application.

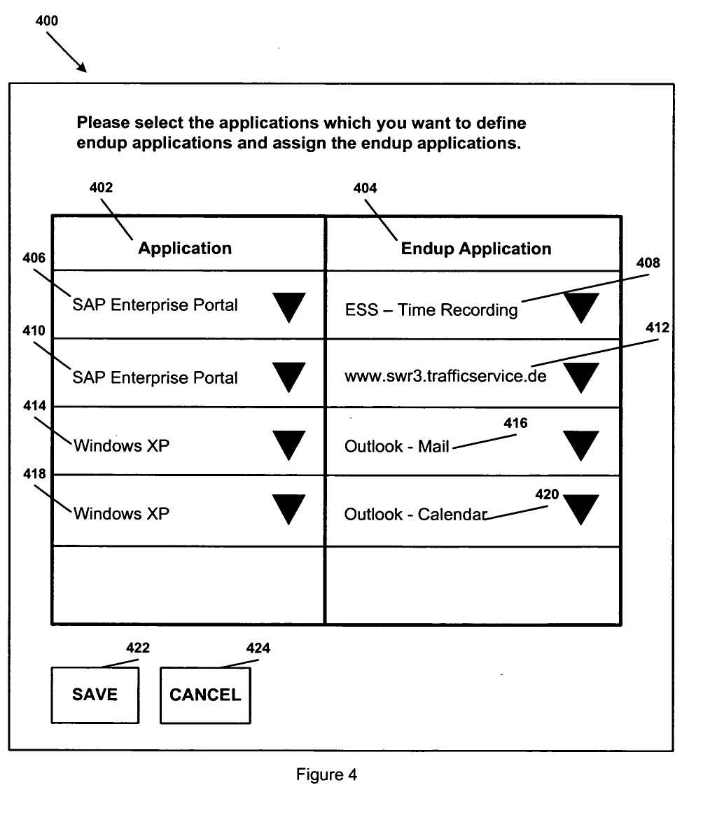

FIG. 4. is an example embodiment of the present invention in a separate application. In application 400, the user may select several applications 402 and correspond them to endup applications 404 which will be automatically launched upon their closure. The applications 402 and endup applications 404 may be selected via drop down boxes, check boxes, or any other mechanism capable of presented numerous applications to a user. For example, the user may wish to associate SAP Enterprise Portal 406 with ESS-Time Recording 408. Then, ESS-Time Recording 408 may be launched when SAP Enterprise Portal 406 is closed. The user may also with to associate SAP Enterprise Portal 410 with a URL, such as www.swr3.trafficservice.de 412. Then, www.swr3.trafficservice.de 412 may also be launched when SAP Enterprise Portal 410 is closed. The user may wish to associate certain applications with the operating system, such as Windows XP. These applications may be launched when the operating system is shut down. For example, the user may wish to associate Outlook-Mail 416 with Windows XP 414. Then, Outlook-Mail 416 may be launched when Windows XP 414 is closed. The user may also wish to associate Outlook-Calendar 420 with Windows XP 418. Then, Outlook-Calendar 420 may be launched when Windows XP 418 is closed. When is the user is finished making his selections, he may press the save 422 button to save his changes. If the user does not want to have his changes take effect, he may press the cancel 424 button.

What is claimed is:

1. A method of launching at least one second operation in response to a closure of a first operation of a computer, comprising:
associating a first operation with at least one second operation;
determining whether the first operation has been closed;
determining the at least one second operation associated with the first operation; and
in response to a closure of the first application, automatically launching the at least one second operation associated with the first operation.

2. The method of claim 1, wherein the first operation is a computer program.

3. The method of claim 1, wherein the first operation is the operating system of the computer.

4. The method of claim 1, wherein the at least one second operation is a computer program.

5. The method of claim 1, wherein the at least one second operation is a URL.

6. The method of claim 1, wherein the associating occurs in a separate computer program.

7. The method of claim 1, wherein the associating occurs in a personalization dialogue of the first operation.

8. An article of manufacture comprising a computer readable medium storing instructions adapted to be executed by a processor, the instructions, when executed, defining a method of launching at least one second operation in response to the closure of a first operation of a computer, the method comprising:
associating a first operation with at least one second operation;
determining whether the first operation has been closed;
determining the at least one second operation associated with the first operation; and
in response to a closure of the first application, automatically launching the at least one second operation associated with the first operation.

9. The article of claim 8, wherein the first operation is a computer program.

10. The article of claim 8, wherein the first operation is the operating system of the computer.

11. The article of claim 8, wherein the at least one second operation is a computer program.

12. The article of claim 8, wherein the at least one second operation is a URL.

13. The article of claim 8, wherein the associating occurs in a separate computer program.

14. The article of claim 8, wherein the associating occurs in a personalization dialogue of the first operation.

15. A computer system for launching a second operation in response to the closure of a first operation, comprising:
an arrangement for associating a first operation with at least one second operation;
an arrangement for determining whether the first operation has been closed;
an arrangement for determining the at least one second operation associated with the first operation; and
an arrangement for launching the at least one second operation associated with the first operation in response to a closure of the first operation.

16. The computer system of claim 15, wherein the first operation is a computer program.

17. The computer system of claim 15, wherein the first operation is the operating system of the computer.

18. The computer system of claim 15, wherein the at least one second operation is a computer program.

19. The computer system of claim 15, wherein the at least one second operation is a URL.

20. The computer system of claim 15, wherein the associating occurs in a separate computer program.

21. The computer system of claim 15, wherein the associating occurs in a personalization dialogue of the first operation.
